(19) United States
(12) Patent Application Publication
(10) Pub. No.: US 2015/0346369 A1
(43) Pub. Date: Dec. 3, 2015

(54) METHODS AND APPARATUS FOR COOPERATIVE NOISE ATTENUATION IN DATA SETS RELATED TO THE SAME UNDERGROUND FORMATION

(71) Applicant: CGG SERVICES SA, Massy (FR)

(72) Inventors: Can PENG, Fulshear, TX (US); Rongxin HUANG, Katy, TX (US); Yi XUAN, Houston, TX (US)

(73) Assignee: CGG SERVICES SA, Massy Cedex (FR)

(21) Appl. No.: 14/432,388

(22) PCT Filed: Sep. 11, 2014
(86) PCT No.: PCT/EP2014/069456

§ 371 Date: Mar. 30, 2015

Related U.S. Application Data
(60) Provisional application No. 61/876,851, filed on Sep. 12, 2013.

(51) Int. Cl. G01V 1/36; G01V 1/30

(52) U.S. Cl. CPC G01V 1/364; G01V 1/308; G01V 2210/324

(57) ABSTRACT

Cooperative attenuation methods are applied to data sets acquired by surveying a same underground formation which therefore include substantially the same primary signal and different individual noise. The data sets are converted in a wavelet basis by applying a high angular resolution complex wavelet transform. When corresponding coefficients of the data set representations in the wavelet basis differ more than predefined thresholds the coefficients are attenuated as corresponding to noise.

### CROSS REFERENCE TO RELATED APPLICATIONS

This application claims priority and benefit from U.S. Provisional Patent Application No. 61/876,851, filed Sep. 12, 2013, for “Cooperative Noise Attenuation in a Complex Wavelet Transform Domain,” the entire content of which is incorporated in its entirety herein by reference.

### BACKGROUND

1. Technical Field

Embodiments of the subject matter disclosed herein generally relate to processing seismic data sets representing the same underground formation. More specifically, noise is attenuated based on comparing the two data sets under the assumption that each data set includes a common primary signal and individual noise.

2. Discussion of the Background

Hydrocarbon exploration and development have been subjected to several step-change technologies during recent decades aimed at extending the life of and maximizing recovery from producing fields (i.e., oil and gas reservoirs). Among these technologies, time-lapse, or four-dimensional (4D), enables observing underground structures' evolution due to and/or during production. This time-lapse technique involves acquisition, processing and interpretation of repeated seismic surveys data over a producing field to achieve efficient reservoir management, identifying producing zones and bypassed oil.

Seismic data includes a signal, which carries information about the investigated underground structure and noise. The signal of interest is sometimes called a primary signal to distinguish it not only from noise but also from its own secondary/multiple echoes. The reliability of the primary signal extracted from the seismic data is substantively affected by adequate and proper noise attenuation. Noise is generally characterized as coherent noise, which can in principle be modeled and extracted from the data, and random noise, which spikes and bursts incoherently.

Various methods of increasing complexity have been developed to isolate and remove noise due to different causes and having different identifiable characteristics. In order to attenuate/remove noise due to an identifiable cause, seismic data is sometimes converted in a domain in which certain types of noise can be separated. A common concern regarding noise attenuation methods is preserving the primary signal. In the context of 4D techniques, this aspect becomes even more important when different data sets acquired for the same area are compared to identify differences indicating real changes. Defective noise removal may obscure real changes or suggest nonexistent changes.

Therefore, in the context of 4D technique, it becomes even more important to develop noise removal methods able to provide the quality and consistency necessary for observing a reservoir's evolution.

### SUMMARY

Noise included in seismic data subsets of a 4D data set is attenuated cooperatively based on the assumption that the subsets are representative of substantially the same primary signal and different noise.

According to an exemplary embodiment, there is a method for cooperative noise attenuation that includes receiving a first data set and a second data set which have been acquired by surveying a same underground formation. The method further includes applying, by a processor, a high angular resolution complex wavelet transform (HARCWT) to both the first and second data sets to obtain a first data set representation and a second data set representation, respectively, in a wavelet basis. The method also includes attenuating at least one first complex coefficient of the first data set representation that differs, according to a first criterion, from a complex coefficient of the second data set representation corresponding to the same wavelet as the first complex coefficient.

According to another embodiment, there is another method for cooperative noise attenuation that includes receiving a first and second data set that are parts of a 4D data set, and time-wrapping the second data set with respect to the first data set. The method further includes applying, by a processor, a HARCWT to the first data set, the second data set and the time-wrapped second data set to obtain a first data set representation, a second data set representation and a time-wrapped second data set representation, respectively, in a wavelet basis. The method also includes extracting a first noise model and a second noise model for the first data set. The first noise model is extracted based on phase differences between complex coefficients that correspond to the same wavelets of the first data set representation and of the time-wrapped second data set representation. The second noise model is extracted based on phase differences between the complex coefficients that correspond to the same wavelets of the first and second data set representations. The method then includes generating a refined noise model for the first data set by attenuating complex coefficients whose amplitudes differ more than a first predetermined value between the first and second noise models, and subtracting the refined noise model from the first data set.

According to another embodiment, there is a data processing apparatus having an interface configured to receive a first data set and a second data set acquired by surveying a same underground formation, and a data processing unit. The data processing unit is configured to apply a HARCWT to the first and second data sets, and to attenuate noise in the first data set representation based on comparing the HARCWT coefficients of the first data set and of the second data set.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a flowchart of a method for cooperative noise attenuation according to an embodiment;

FIG. 2 is the data flow for the method of FIG. 1;

FIG. 3 is a graph of wave-number versus frequency showing a HARCWT division;

FIG. 4 is an illustration of wavelets corresponding to the highest frequency and wave number bands in FIG. 3;

FIG. 5 is a seismic data image;

FIG. 6 illustrates the real part of HARCWT coefficients obtained for the seismic data in FIG. 5;

FIG. 7 illustrates the imaginary part of HARCWT coefficients obtained for the seismic data in FIG. 5;

FIG. 8 is a flowchart of a method for cooperative noise attenuation according to another embodiment;

FIG. 9 is the data flow for the method of FIG. 8; and

FIG. 10 is a schematic diagram of an apparatus configured to perform cooperative noise attenuation of seismic data sets according to an embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology of 4D seismic data processing. However, the embodiments to be discussed next are not limited to 4D data sets or seismic data, but may be applied to other data sets carrying the same signal and different noise.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

4D data set processing augments the requirements of quality and consistency in noise attenuation in order to correctly identify changes in the surveyed underground structure. However, the fact that the same underground structure is surveyed also creates an opportunity, making it reasonable to assume that different data sets include substantially the same primary signal, which is contaminated by different independent noise. Starting from this assumption, the data sets represented in a directional 2D complex wavelet are compared to attenuate (as corresponding to noise) one or more of their coefficients in this representation, when coefficients of the two data set representations corresponding to a same wavelet differ more than predetermined thresholds.

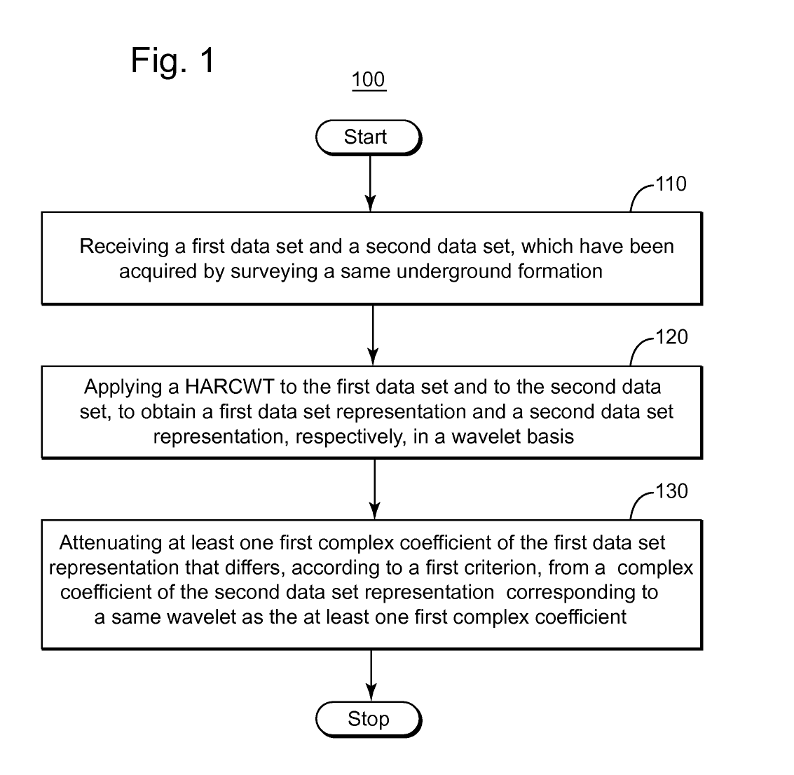

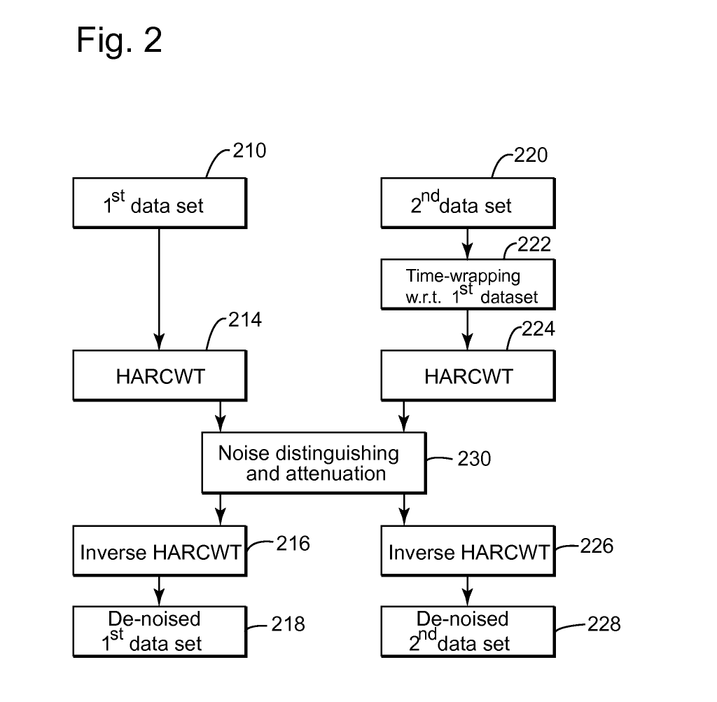

FIG. 1 is a flowchart of a method 100 for cooperative noise attenuation according to an embodiment. FIG. 2 is the data flow for method 100. Method 100 includes receiving a first data set (e.g., 210 in FIG. 2) and a second data set (e.g., 220 in FIG. 2), which have been acquired by surveying a same underground formation, at 110. The data sets may be seismic or electromagnetic. The data sets may have been acquired during a marine or land survey. The data sets may be 3D subsets of a 4D data set.

In order to avoid artifacts due to time shifts unrelated to changes in the underground structure (e.g., due to different water depths or different wave propagation velocities in water) one of the data sets may be subjected to an initial time alignment relative to the other data set, an operation known as “time-wrapping” the second data set with respect to the first data set. The resulting time-wrapped second data set is illustrated as 222 in FIG. 2. However, time-wrapping is an optional operation.

Returning to FIG. 1, method 100 further includes, at 120, applying a high angular resolution complex wavelet transform (HARCWT) to the first data set and to the (time-wrapped) second data set, to obtain a first data set representation (i.e., 214 in FIG. 2) and a second data set representation (i.e., 224 in FIG. 2), respectively, in a wavelet basis. This data processing is performed using a computer (i.e., by a processor). HARCWT is a directional complex (2D) wavelet transform, which has adaptive directional wavelet basis, i.e., higher frequency bands have more directional wavelet bases than lower frequency bands. HARCWT is described in the article “Shear noise attenuation and PZ matching with a new scheme of complex wavelet transform” by C. Peng, R. Huang and B. Asmerom, published in 75^{th} EAGE Conference and Exhibition incorporating SPE EUROPEC 2013, London, UK, 10-13 Jun. 2013, which is incorporated herein by reference. HARCWT separates input data (i.e., data to which the transform is applied) based on dipping directions, frequency bands and their location.

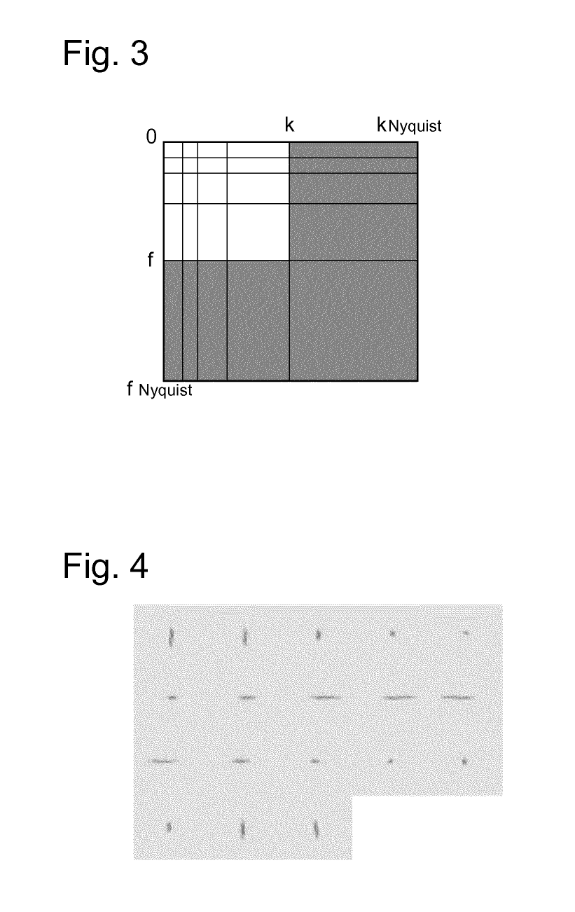

FIG. 3 is a graph of wave-number (k), which is in the range 0-K_{Nyquist} on x axis, and frequency (f), which is in the range 0-f_{Nyquist} on y axis (pointing down). The grid on this graph is the f-k division of HARCWT. FIG. 4 shows the wavelets of the highest f and k bands shadowed in FIG. 3. The relatively large number of wavelet bases' provides a high angular resolving capability, when data (including an input signal) is represented using these wavelet bases. The representation is achieved by convoluting the wavelet bases with data. The representation's coefficients provide information about location, amplitude and phase of the input signal. The embodiments are not limited to this specific transform, other complex wavelet/curvelet transforms may be used. Regardless of the implementation details, the phase and/or amplitude differences in the transform domain are used to distinguish the coefficients that stand for noise energy, to then attenuate them. The real/desired signals are not diluted by this type of processing, because the complex transforms are sparse for real signal (which means in the transform domain, only a small portion of coefficients represents the desired signal) causing noise and signal to be well separated by the transform. Therefore, the real signal is untouched after processing.

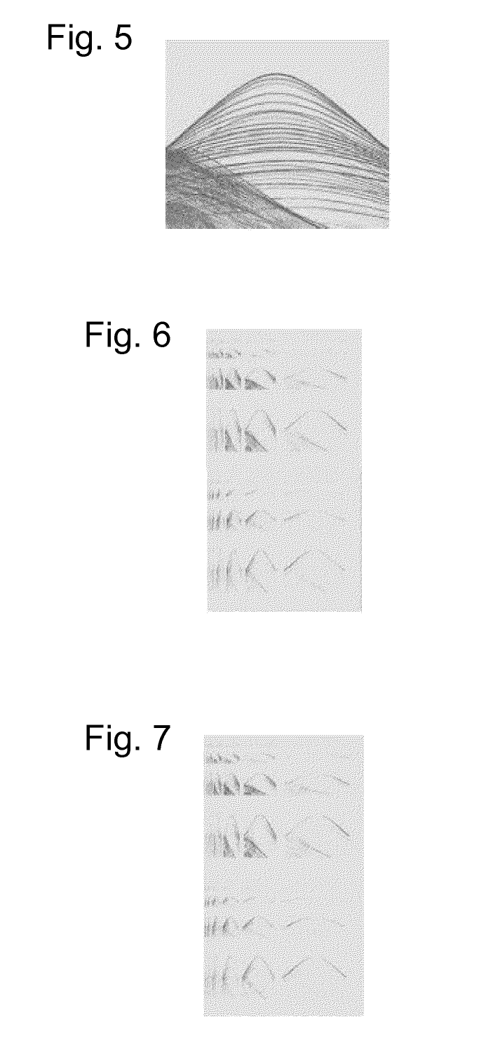

Applying HARCWT to seismic data, which may be visualized as an image, results in complex transform coefficients. FIG. 5 is a seismic data image (x axis corresponding to horizontal position, y axis corresponding to time/depth, and the darker a shade of gray, the greater detected signal amplitude. FIG. 6 illustrates the real part of HARCWT coefficients obtained for the seismic data in FIG. 5, and FIG. 7 illustrates the imaginary part of HARCWT coefficients obtained for the seismic data illustrated in FIG. 5 (with x and y axes being the same as in FIG. 5 and shades of gray corresponding to real or imaginary coefficients' magnitude). The upper half of FIG. 5 illustrates coefficients of wavelet bases with positive orientation angles (from northwest to southeast), and the lower half thereof illustrates coefficients of wavelet bases with negative orientation angles (from southwest to northeast).

One advantage of using HARCWT is the sparse representation, i.e., coherent events usually are represented by a small number of coefficients. This property makes it unlikely that attenuation of inconsistent coefficients in the noise removal procedure affects primary related events. HARCWT can be extended to a 3D transform, leading to an even better event separation.

The HARCWT complex coefficients carry on the information regarding the underground substructure, the energy (i.e., amplitude) of events with different dipping angles having impact on coefficients in different panels (i.e., corresponding to different wavelets) after the transform. The primary related coefficients have the same amplitude and phase in the two data sets, while the different noise yields different coefficients for the same wavelet in the two data sets.

Returning again to FIGS. 1 and 2, method 100 further includes, at 130, attenuating at least one first complex coefficient of the first data set representation that differs, according to a first criterion, from a complex coefficient of the second data set representation corresponding to a same wavelet as the at least one first complex coefficient. Although operation 130 is defined as referring to at least one coefficient, it is reasonable to assume that the noise distinguishing and attenuation is performed for all the coefficients. In other words, in one embodiment, any complex coefficient of the first data set representation that differs, according to the first criterion, from a complex coefficient of the second data set representation corresponding to a same wavelet is attenuated.

Moreover, since the coefficients corresponding to the same wavelet are compared, it would be efficient to also attenuate noise in the second data set following the comparison. In other words, in one embodiment, at least one second complex coefficient of the second data set representation that differs, according to a second criterion, from a complex coefficient of the first data set representation corresponding to a same wavelet as the at least one first complex coefficient, is attenuated. In another embodiment, when the first criterion is met, both coefficients (i.e., of the first and second data set representations) are attenuated.

The first and second criteria may be substantially the same, but it is not required. For instance, if one of the data sets appears to be noisier than the other, the criteria may be set to account for such difference. In a related aspect, a first attenuation factor applied to attenuate at least one first complex coefficient may be equal to a second attenuation factor applied to attenuate at least one second complex coefficient, but this equality relationship is optional.

Focusing now on the coefficient differentiation criterion itself, in one embodiment, the first criterion is that a difference between a phase of the first complex coefficient, and a phase of the corresponding complex coefficient of the second data set representation, exceeds a predetermined threshold. In another embodiment, the criterion is that an amplitude (i.e., square root of the sum of squared real and imaginary parts of the complex coefficient) of the first complex coefficient is larger than an amplitude of the corresponding complex coefficient of the second data set representation by more than a predetermined value. Any combination and multiple tier scheme of the above phase- and amplitude-related conditions may be used as differentiation criteria. The second criterion may be defined in a similar manner.

After noise distinguishing and attenuation (i.e., 230 in FIG. 2), an inverse HARCWT may be applied to the attenuated representations (216 and 226 in FIG. 2) to obtain a de-noised first data set 218 and a de-noised second data set 228, respectively.

Although the above methods are explained in terms of two data sets, similar methods may be used for plural data sets. In the case of noise attenuation applied to plural data sets, the criterion may be defined relative to a semblance of the coefficients for the data sets.

If the first and second data sets include not only timing differences but also difference in wavelet phases, a cross-checking process is interleaved to avoid smearing real 4D difference. A method including this cross-checking may perform:

1. extracting a direct noise model based on the phase difference between corresponding coefficients (i.e., in the transform domain) of two data sets;
2. extracting a time-aligned noise model based on the phase difference between corresponding coefficients of the time-aligned two data sets;
3. merging the direct noise model and the time-aligned noise model; and
4. subtracting the merged noise model from the two data sets.
This approach is merely exemplary and it is not intended to be exclusive. Other known cross-checking mechanisms may be employed. For example, instead of time-wrapping, the second data set may be modified to make its primaries closer to the ones in the first data set by local amplitude or spectrum matching.

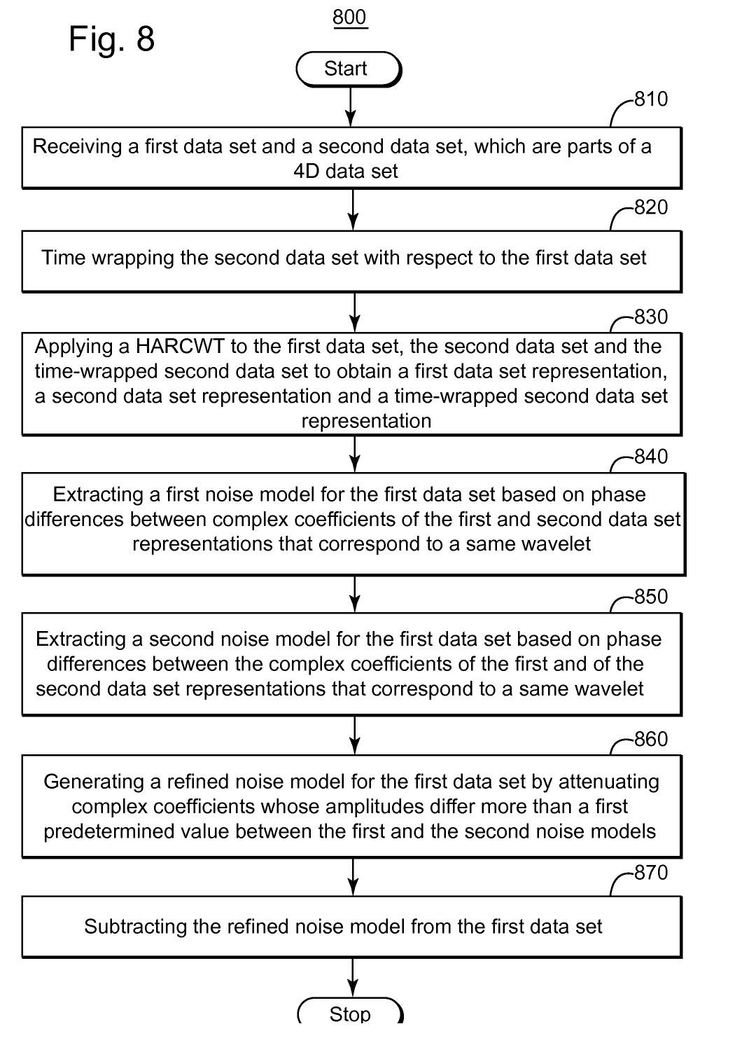

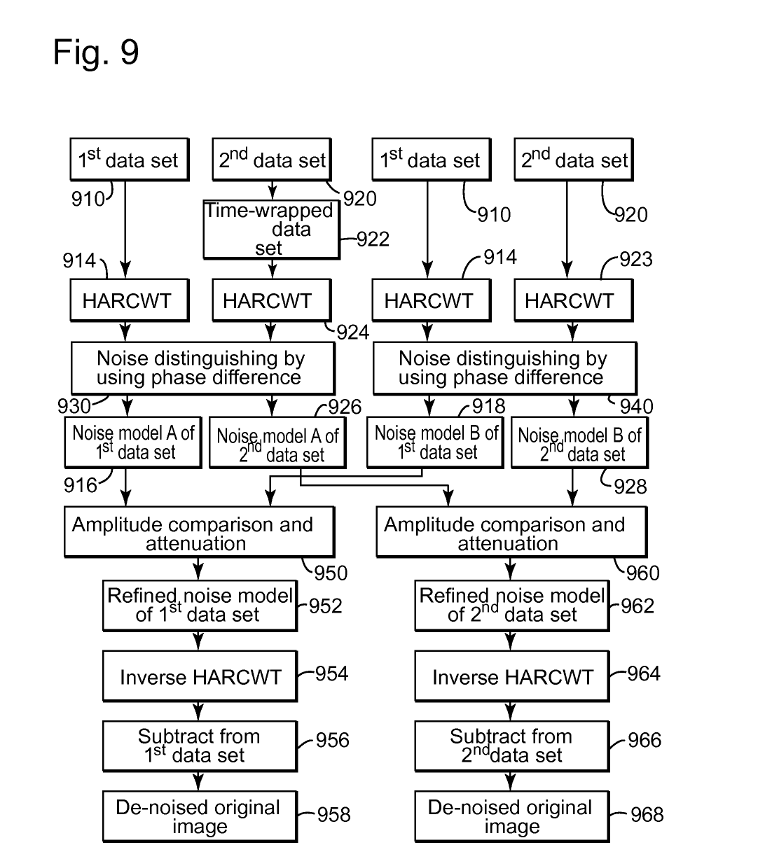

FIG. 8 is a flowchart of a method 800 for cooperative noise attenuation according to an exemplary embodiment of a method including the cross-checking process. FIG. 9 is the data flow for the method in FIG. 8. Method 800 includes, at 810, receiving a first data set (910 in FIG. 9) and a second data set (920), which have been acquired by surveying a same underground formation. The first and second data sets may be parts of a 4D data set. Method 800 then includes time-wrapping the second data set with respect to the first data set at 820. In other words, time shifts between the two data sets due to causes other than changes in the surveyed underground structure are eliminated. The result of 820 is a time-wrapped second data set (922), which matches certain features of the first.

Method 800 further includes, at 830, applying a HARCWT to the first data set, the second data set and the time-wrapped second data set to obtain a first data set representation (914), a second data set representation (923) and a time-wrapped second data set representation (924), respectively, in a wavelet basis.

Method 800 then includes, at 840, extracting a first noise model (916) for the first data set based on phase differences between complex coefficients of the first data set representation (914) and of the time-wrapped second data set (924) representation that correspond to a same wavelet. This data processing labeled as 930 in FIG. 9 is substantively different from data processing occurring at 230 in FIG. 2, where the result is one (or both attenuated data sets). The output of 930 is a time-aligned noise model for at least one of the data sets. In fact, it is efficient to extract in the same time a time-aligned noise model (916) for the first data set, and a time-aligned noise model (926) for the second data set. In other embodiments, various combinations of amplitude and/or phase related rules may be used (i.e., instead of 930, 940, 950 and 960) to generate the initial noise models (916, 918, 926, 928) and/or the refined noise models (952 and 962).

Method 800 then includes, at 850, extracting a second noise model (918) for the first data set based on phase differences between the complex coefficients of the first data set representation and of the second data set representation that correspond to a same wavelet. This data processing labeled as 940 in FIG. 9 may at the same time yield a second noise model (928) for the second data set.

Method 800 then includes, at 860, generating a refined noise model (952) for the first data set by attenuating complex coefficients whose amplitudes differ more than a first predetermined value between the first noise model and the second noise model. Thus, as illustrated in FIG. 9, HARCWT coefficients of the first noise model 916 and of the second noise model 918 for the first data set are compared at 950 to generate a single refined noise model 952 for the first data set. At the same time, HARCWT coefficients of the first noise model 926 and of the second noise model 928 for the second data set may be compared at 960 to generate a single refined noise model 962 for the second data set. An inverse HARCWT may then be applied to the refined noise models to convert them in regular seismic data space, 954 and 964, respectively.

Method 800 then includes, at 870, subtracting the refined noise model for the first data set from the first data set. At the same time, the refined noise model for the second data set may also be subtracted from the second data set. The subtraction of the refined noise models may be subtracted in regular seismic data space as illustrated at 956 and 966 in FIG. 9, or, alternatively the refined noise models may be subtracted from the seismic data in HARCWT transform domain, the result of the subtraction being then converted back by applying inverse HARCWT in the regular seismic data space.

The result of applying method 800 and its variations described above is/are de-noised data set(s) 958 (and 968).

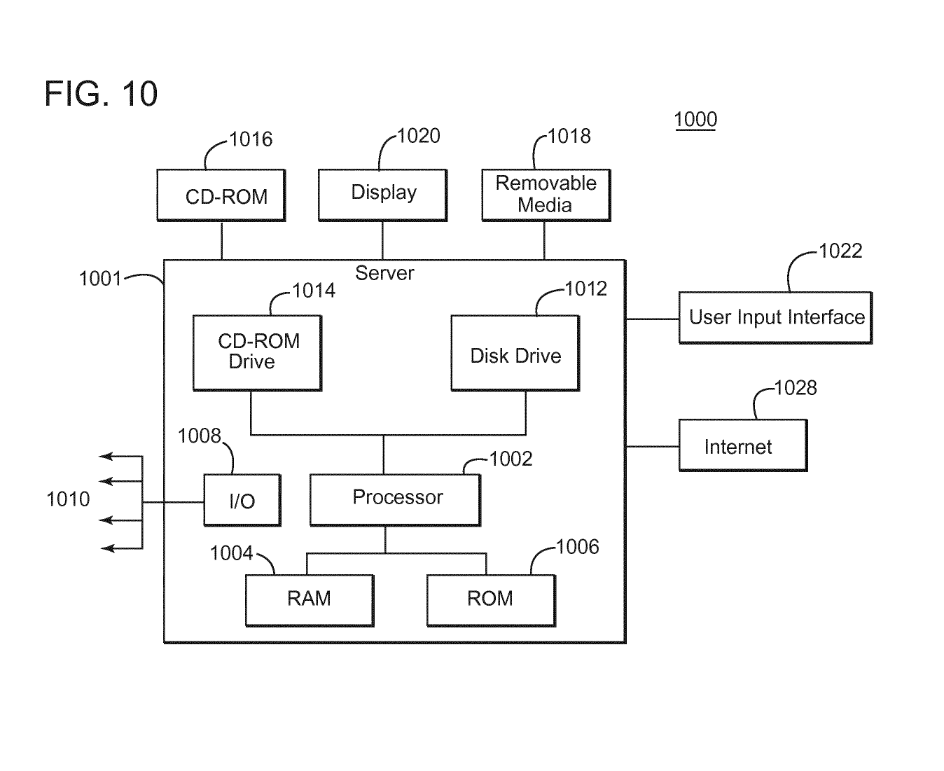

An example of a representative processing device 1000 capable of carrying out methods 100 and 800 or their alternatives discussed above is illustrated in FIG. 10. Hardware, firmware, software or a combination thereof may be used to perform the various steps and operations. Processing device 1000 may include server 1001 having a central processor unit (CPU) 1002 coupled to a random access memory (RAM) 1004 and to a read-only memory (ROM) 1006. ROM 1006 may also be other types of storage media to store programs, such as programmable ROM (PROM), erasable PROM (EPROM), etc. Methods for attenuating random noise according to various embodiments described in this section may be implemented as computer programs (i.e., executable codes) non-transitorily stored on RAM 1004 or ROM 1006.

Processor 1002 may communicate with other internal and external components through input/output (I/O) circuitry 1008 and bussing 1010, which are configured to receive the first data set and the second data set acquired by surveying the same underground formation. Processor 1002 carries out a variety of seismic data processing functions known in the art, as dictated by software and/or firmware instructions, and may include plural processing elements cooperating to perform the data processing functions. Processor 1002 is also configured to apply a HARCWT to the first and second data sets, and to attenuate noise in the first data set and/or in the second data set based on comparing the HARCWT coefficients of the first and second data sets. In one embodiment, processor 1002 may further be configured to attenuate at least one second complex coefficient of the time-wrapped second data set representation that differs from a corresponding complex coefficient of the first data set representation according to a first criterion.

In another embodiment, processor 1002 may be further configured (i) to time-wrap (align) the second data set relative to the first data set, (ii) to apply a HARCWT to the time-wrapped second data set, (iii) to extract a first noise model for the first data based on phase differences between HARCWT complex coefficients corresponding to the first data set representation and corresponding to the second data set, (iv) to extract a second noise model for the first data based on phase differences between HARCWT complex coefficients corresponding to the first data set representation and corresponding to the time-wrapped second data set, (v) to generate a refined noise model for the first data set by attenuating complex coefficients whose amplitudes differ more than a first predetermined value between the first noise model and the second noise model, and (vi) to subtract the refined noise model from the first data set to obtain a de-noised first data set. Processor 1002 may then also be configured to apply an inverse of the HARCWT to the refined noise model of the first data set or to the de-noised first data set.

Server 1001 may also include one or more data storage devices, including disk drive 1012, CD-ROM drive 1014, and other hardware capable of reading and/or storing information, such as a DVD, etc. In one embodiment, software for carrying out the above-discussed steps may be stored and distributed on a CD-ROM 1016, removable media 1018 or other form of media capable of storing information. The storage media may be inserted into, and read by, devices such as the CD-ROM drive 1014, disk drive 1012, etc. Server 1001 may be coupled to a display 1020, which may be any type of known display or presentation screen, such as LCD, plasma display, cathode ray tube (CRT), etc. Server 1001 may control display 1020 to exhibit images generated using seismic data or the HARCWT coefficients such as in FIGS. 5-7. A user input interface 1022 is provided, including one or more user interface mechanisms such as a mouse, keyboard, microphone, touch pad, touch screen, voice-recognition system, etc.

Server 1001 may be coupled to other computing devices, such as the equipment of a vessel, via a network. The server may be part of a larger network configuration as in a global area network (GAN) such as the Internet 1028, which allows ultimate connection to various landline and/or mobile devices.

The disclosed exemplary embodiments provide methods and devices for noise attenuation in seismic data. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A method for cooperative noise attenuation,
the method comprising:
receiving a first data set and a second data set which have been acquired by surveying a same underground formation;
applying, by a processor, a high angular resolution complex wavelet transform (HARCWT) to the first data set and to the second data set, to obtain a first data set representation and a second data set representation, respectively, in a wavelet basis;
attenuating at least one first complex coefficient of the first data set representation that differs, according to a first criterion, from a complex coefficient of the second data set representation corresponding to a same wavelet as the at least one first complex coefficient; and
attenuating at least one second complex coefficient of the second data set representation that differs, according to a second criterion, from a complex coefficient of the first data set representation corresponding to a same wavelet as the at least one first complex coefficient.

2. The method of claim 1, further comprising:
applying an inverse of the HARCWT to the first data set representation including the attenuated at least one first complex coefficient, to obtain a first noise-attenuated data set.

3. (canceled)

4. The method of claim 1, wherein the first criterion is substantially similar to the second criterion.

5. The method of claim 1, wherein a first attenuation factor applied to attenuate the at least one first complex coefficient is equal to a second attenuation factor applied to attenuate the at least one second complex coefficient.

6. The method of claim 1, wherein
the first criterion is that a difference between a phase of the at least one first complex coefficient, and a phase of the corresponding complex coefficient of the second data set representation exceeds a predetermined threshold.

7. The method of claim 1, wherein the first criterion is that an amplitude of the at least one first complex coefficient is larger than an amplitude of the corresponding complex coefficient of the second data set representation by more than a predetermined value.

8. The method of claim 1, wherein the first data set and the second data set are parts of a 4D data set, the method further comprising:
time wrapping the second data set with respect to the first data set before applying the HARCWT to the second data set.

9. The method of claim 1, wherein the first and the second data sets are acquired by performing a land seismic survey.

10. The method of claim 1, wherein the first and the second data sets are acquired by performing a marine seismic survey.

11. The method of claim 1, wherein the first and the second data sets are electromagnetic data.

12. The method of claim 1, wherein any complex coefficient of the first data set representation that differs, according to the first criterion, from a complex coefficient of the second data set representation corresponding to a same wavelet is attenuated.

13. A method for cooperative noise attenuation,
the method comprising:
receiving a first data set and a second data set which have been acquired by surveying a same underground formation;
time wrapping the second data set with respect to the first data set;
applying, by a processor, a HARCWT to the first data set and to the second data set and the time-wrapped second data set to obtain a first data set representation, a second data set representation and a time-wrapped second data set representation, respectively, in a wavelet basis;
extracting a first noise model for the first data set based on phase differences between complex coefficients of the first data set representation and of the time-wrapped second data set representation that correspond to a same wavelet;
extracting a second noise model for the first data set based on phase differences between the complex coefficients of the first data set representation and of the second data set representation that correspond to a same wavelet;
generating a refined noise model for the first data set by attenuating complex coefficients whose amplitudes differ more than a first predetermined value between the first noise model and the second noise model; and
subtracting the refined noise model from the first data set to obtain a de-noised first data set.

14. The method of claim 13, further comprising:
applying an inverse of the HARCWT to the refined noise model for the first data set before the subtracting from the first data set.

15. The method of claim 13, further comprising:
extracting a first noise model for the second data set based on phase differences between the corresponding complex coefficients of the first data set representation and of the time-wrapped second data set representation;
extracting a second noise model for the second data set based on phase differences between the corresponding complex coefficients of the first data set representation and of the second data set representation;
generating a refined noise model for the second data set by attenuating complex coefficients whose amplitude differ more than a second predetermined value between the first noise model and the second noise model for the second data set; and
subtracting the refined noise model for the second data set, from the second data set to obtain de-noised second data set.

16. The method of claim 15, further comprising:
applying an inverse of the HARCWT to the refined noise model for the second data set before the subtracting from the second data set.

17. A data processing apparatus configured to perform cooperative noise attenuation of seismic data sets, the apparatus comprising:
an interface configured to receive a first data set and a second data set acquired by surveying a same underground formation; and
a data processing unit configured
to apply a HARCWT to the first data set and to the second data set; and
to attenuate noise in the first data set based on comparing the HARCWT coefficients of the first data set and of the second data set;
wherein the data processing unit is further configured to attenuate at least one second complex coefficient of the time-wrapped second data set representation that differs from a corresponding complex coefficient of the first data set representation according to a first criterion.

18. (canceled)

19. The data processing apparatus of claim 17, wherein the data processing unit is further configured
to time wrap the second data set relative to the first data set,
to apply a HARCWT to the time-wrapped second data set,
to extract a first noise model for the first data based on phase differences between HARCWT complex coefficients corresponding to the first data set representation and corresponding to the second data set,
to extract a second noise model for the first data based on phase differences between HARCWT complex coefficients corresponding to the first data set representation and corresponding to the time-wrapped second data set,
to generate a refined noise model for the first data set by attenuating complex coefficients whose amplitudes differ more than a first predetermined value between the first noise model and the second noise model, and
to subtract the refined noise model from the first data set to obtain a de-noised first data set.

20. The data processing apparatus of claim 19, wherein the data processing unit is further configured to apply an inverse of the HARCWT to the refined noise model of the first data set or to the de-noised first data set.

21. The method of claim 1, further comprising:
applying an inverse of the HARCWT to the second data set representation including the attenuated at least one second complex coefficient, to obtain a second noise-attenuated data set.

22. The method of claim 1, wherein
the second criterion is that a difference between a phase of the at least one second complex coefficient, and a phase of the corresponding complex coefficient of the first data set representation exceeds a predetermined threshold.
